(19) United States
(12) Patent Application Publication
(10) Pub. No.: US 2016/0095051 A1
(43) Pub. Date: Mar. 31, 2016

(54) ASSISTED DISCOVERY SCANS FOR INDOOR POSITION DETERMINATION

(71) Applicant: QUALCOMM Incorporated, San Diego, CA (US)

(72) Inventors: Subash MARRI SRIDHAR, San Jose, CA (US); Sai Pradeep VENKATRAMAN, Santa Clara, CA (US); Gengsheng ZHANG, Cupertino, CA (US)

(21) Appl. No.: 14/502,955

(22) Filed: Sep. 30, 2014

(51) Int. Cl. H04W 48/16; H04W 48/14; H04W 64/00

(52) U.S. Cl. CPC H04W 48/16; H04W 64/006; H04W 48/14

(57) ABSTRACT

Techniques for determining a position of a mobile device are provided. An example of these techniques is a method that includes performing a passive scan for wireless transceivers proximate to the mobile device to generate passive scan results, generating a first wireless transceiver list, comprising a first set of wireless transceivers, transmitting a request to at least one wireless transceiver from the first wireless transceiver list requesting that the at least one wireless transceiver perform a scan, generating a second wireless transceiver list comprising identifying information for a second set of wireless transceivers, proximate to the at least one wireless transceiver, measuring signals received from wireless transceivers selected from at least one of the first wireless transceiver list and the second wireless transceiver list, and determining the position of the mobile device based at least in part on the signals measured.

### BACKGROUND

Many mobile devices utilize position determination techniques to provide location based-services to the user of the mobile device, such as navigation applications, map information, content targeted to the location of the mobile device, and/or other location-based services. The mobile device can be configured to use signals from various types of wireless transceivers, including wireless access points providing Wireless Local Area Network (WLAN) connectivity and/or wireless base stations providing Wireless Wide Area Network (WWAN) connectivity (macrocells, picocells, microcells, femtocells, and/or other types of WWAN base station) can be used to determine the position of a mobile device.

The mobile device can be configured to perform scans to detect wireless transceivers proximate to the mobile device. The signals from these scans can be used to determine a position of the mobile device. Performing such scans can require significant resources on the mobile device, and can significantly impact the battery life of the mobile device.

### SUMMARY

An example method for determining a position of the mobile device according to the disclosure includes performing a passive scan for wireless transceivers proximate to the mobile device to generate passive scan results, generating a first wireless transceiver list, comprising a first set of wireless transceivers, transmitting a request to at least one wireless transceiver from the first wireless transceiver list requesting that the at least one wireless transceiver perform a scan for wireless transceivers, receiving scan results from the at least one wireless transceiver from the first wireless transceiver list, generating a second wireless transceiver list comprising identifying information for a second set of wireless transceivers, proximate to the at least one wireless transceiver, measuring signals received from wireless transceivers selected from the first wireless transceiver list, or the second wireless transceiver list, or combination thereof, and determining the position of the mobile device based at least in part on the signals measured.

Implementations of such a method may include one or more of the following features. The request comprises a wireless local area network (WLAN) Radio Measurement frame comprising a Beacon Request. The request comprises a request to perform an active scan for the wireless transceivers. The request comprises a request to perform a passive scan for the wireless transceivers. Periodically performing additional passive scans for the wireless transceivers proximate to the mobile device, and updating the first wireless transceiver list based on results of the additional passive scans. Updating the first wireless transceiver list includes removing one or more wireless transceivers from the first wireless transceiver list responsive to a signal strength associated with each of the one or more wireless transceivers from the first wireless transceiver list falling below a first predetermined threshold. Updating the first wireless transceiver list includes adding one or more wireless transceivers that are currently not on the first wireless transceiver list to the first wireless transceiver list responsive to the signal strength associated with each of the one or more wireless transceivers that are currently not on the first wireless transceiver list exceeding a second predetermined threshold. The wireless transceivers comprise WLAN access points.

An example mobile device for determining the position of the mobile device according to the disclosure includes a tangible, non-transitory computer-readable memory, a processor connected to the tangible, non-transitory computer-readable memory, and a transceiver configured to perform a passive scan for wireless transceivers proximate to the mobile device to generate passive scan results. The processor is configured to generate a first wireless transceiver list, comprising a first set of wireless transceivers. The transceiver is further configured to transmit a request to at least one wireless transceiver from the first wireless transceiver list requesting that the at least one wireless transceiver perform a scan for wireless transceivers and to receive scan results from the at least one wireless transceiver from the first wireless transceiver list. The processor is further configured to generate a second wireless transceiver list comprising identifying information for a second set of wireless transceivers, proximate to the at least one wireless transceiver, measure signals received from wireless transceivers selected from the first wireless transceiver list, or the second wireless transceiver list, or combination thereof, and determine the position of the mobile device based at least in part on the signals measured.

Implementations of such a mobile device may include one or more of the following features. The request comprises a wireless local area network (WLAN) Radio Measurement frame comprising a Beacon Request. The request comprises a request to perform an active scan for the wireless transceivers. The request comprises a request to perform a passive scan for the wireless transceivers. The processor is further configured to periodically perform additional passive scans for the wireless transceivers proximate to the mobile device, and update the first wireless transceiver list based on results of the additional passive scans. The processor is further configured to remove one or more first wireless transceivers from the first wireless transceiver list responsive to a signal strength associated with each of one or more wireless transceivers from the first wireless transceiver list falling below a first predetermined threshold. The processor is further configured to add one or more second wireless transceivers currently not on the first wireless transceiver list to the first wireless transceiver list responsive to the signal strength associated with each of the one or more second wireless transceivers currently not on the first wireless transceiver list exceeding a second predetermined threshold.

An example method for disambiguation of a location context associated with a mobile device according to the disclosure includes performing a scan for wireless transceivers proximate to the mobile device to generate discovery scan results from the scan for wireless transceivers proximate to the mobile device, generating a first wireless transceiver list based on the discovery scan results from the scan for wireless transceivers proximate to the mobile device, the first wireless transceiver list comprising a first subset of the wireless transceivers proximate to the mobile device, and wherein wireless transceivers in the first subset of the wireless transceivers proximate to the mobile device are associated with a first location context identifier (LCI) with which the mobile device is associated, generating a second wireless transceiver list based on the first discovery scan results, the second wireless transceiver list comprising a second subset of the wireless transceivers proximate to the mobile device, and wherein wireless transceivers in the second subset of the wireless transceivers proximate to the mobile device are associated with a second LCI, wherein the second LCI is different from the first LCI, transmitting a first scan request to at least one wireless transceiver from the first wireless transceiver list requesting the at least one wireless transceiver from the first wireless transceiver list perform a scan for wireless transmitters proximate to the at least one wireless transceiver from the first wireless transceiver list, transmitting a second scan request to at least one wireless transceiver from the second wireless transceiver list requesting the at least one wireless transceiver from the second wireless transceiver list perform a discovery scan for wireless transmitters proximate to the at least one wireless transceiver from the second wireless transceiver list, receiving discovery scan results from the at least one wireless transceiver from the first wireless transceiver list, receiving discovery scan results from the at least one wireless transceiver from the second wireless transceiver list, comparing the discovery scan results from the scan for wireless transceivers proximate to the mobile device with the discovery scan results from the at least one wireless transceiver from the first wireless transceiver list and the discovery scan results from the at least one wireless transceiver from the second wireless transceiver list, and determining an LCI associated with a portion of an indoor environment in which the mobile device is located based at least in part on results of comparison.

Implementations of such a method may include one or more of the following features. The first scan request or the second scan request or both comprise a request to perform an active scan for the wireless transceivers. The first scan request or the second scan request or both comprise a request to perform a passive scan for the wireless transceivers. Determining an LCI associated with a portion of an indoor environment in which the mobile device is located based at least in part on results of comparison further comprises selecting the LCI based on a number of wireless transceivers included in the discovery scan results from the scan for wireless transceivers proximate to the mobile device, the discovery scan results from the at least one wireless transceiver from the first wireless transceiver list, and the discovery scan results from the at least one wireless transceiver from the second wireless transceiver list associated with the LCI.

### BRIEF DESCRIPTION OF THE DRAWINGS

FIG. 1 is a block diagram of an example network architecture, which may be suitable for an implementing the techniques discussed herein.

FIG. 2 is a block diagram of a mobile device that can be used to implement the mobile device illustrated in FIG. 1.

FIG. 3 is a functional block diagram of the mobile device illustrated in FIG. 2 that illustrates functional modules of the memory shown in FIG. 2.

FIG. 4 is a block diagram of a wireless transceiver that can be used to implement the wireless transceivers illustrated in FIG. 1.

FIG. 5 is a functional block diagram of the wireless transceiver illustrated in FIG. 4 that illustrates functional modules of the memory shown in FIG. 4.

FIG. 6 is a flow diagram of a process for determining the position of a mobile device using the assisted discovery scanning techniques discussed herein.

FIG. 7 is a flow diagram of a process for providing assistance data to a mobile device according to the assisted discovery scanning techniques discussed herein.

FIG. 8 is a flow diagram of a process for LCI disambiguation using the passive scanning techniques discussed herein

FIGS. 9A and 9B are diagrams that illustrate how a wireless transceivers list may be updated as a mobile device moves through an indoor environment.

### DETAILED DESCRIPTION

Techniques disclosed herein are configured to provide for assisted discovery scans in which the mobile device receives assistance from one or more wireless transceivers proximate to the mobile device in scanning for wireless transceivers proximate to the mobile device. The techniques disclosed herein can be applied to indoor positioning techniques in which the mobile device scans for one or more wireless transceivers the signals from which can be used to determine the position of the mobile device. The mobile device can be configured to perform active and/or passive scans for wireless transceivers. Example implementations are provided herein in which the mobile device is configured to request assisted discovery scans from WLAN wireless access points, but the techniques disclosed herein are not limited to WLAN wireless access points and can also be used with other types of wireless transceivers the signals from which can be used to determine the position of a mobile device. The wireless transceivers can comprise wireless transceivers that are located at fixed locations, or the wireless transceivers may be movable but generally do not change location, such that the locations of the wireless transceivers can be used to determine a location of the mobile device.

The techniques disclosed herein can provide several advantages over conventional indoor discovery scans performed by the mobile device. For example, a mobile device using a conventional discovery scan technique may be configured to perform either a passive or active scan for nearby wireless transceivers every ten seconds. The mobile device may take at least three seconds to scan all of the channels in just the 2.4 GHz band when performing such a scan. Furthermore, the environment around the mobile device may be continually changing as the mobile device moves through the indoor environment, which can negatively impact the performance of the scan. The technique disclosed herein can provide improved results over conventional scans where the entire scan is performed by the mobile device. For example, the detection range of the mobile device may be much less than that of a wireless transceiver, such as a WLAN wireless access point or other wireless transceiver. In the techniques disclosed herein, the wireless access points are used to perform at least some scanning on behalf of the mobile device, which may result in scan detecting wireless transceivers that may have otherwise been missed by the mobile device due to the increased sensitivity of the wireless transceivers. The wireless transceivers may also discover wireless transceivers that do not broadcast identity information (e.g., a wireless access point that does not transmit it's SSID), because the wireless transceivers are able to scan multiple channels in parallel on behalf of the mobile device and can listen longer on each channel for transmissions that can be used to identify wireless transceivers that do not broadcast identity information. Furthermore, by handing off at least a portion of the scan to one or more wireless transceivers proximate to the mobile device, the mobile device can conserve power and processing resources that would otherwise be expended on the discovery scan. The wireless transceivers typically are powered by an external power supply and rather than a battery or other such power supply, and thus, are not constrained by available power available of the battery or other such power supply.

### Example Network Environment

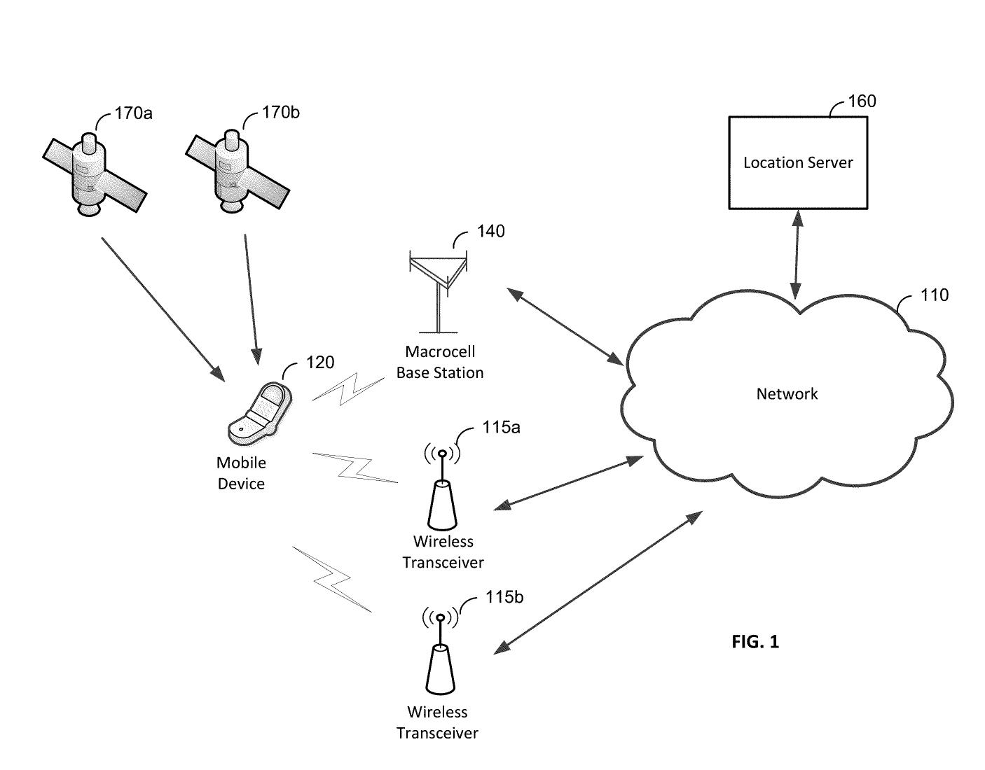

FIG. 1 is a block diagram of an example network architecture, which may be suitable for an implementing the techniques discussed herein. The particular configuration illustrated herein is merely an example of one network configuration in which the techniques disclosed herein may be used. Furthermore, an implementation of such a network architecture may include additional elements that are not illustrated herein and have been omitted for the sake of clarity.

The mobile device 120 may also be referred to as a User Equipment (UE), a mobile station, a terminal, an access terminal, a subscriber unit, a station, etc. The mobile device 120 may be a smartphone, a tablet computer, a laptop computer, or other device that includes a wireless transceiver that is configured to communicate using one or more wireless communications protocols, including, but not limited to, the Long Term Evolution (LTE), WiFi, and WiMAX wireless communications protocols. The mobile device 120 can also be configured to support other types of wireless communications protocols and can be configured to support multiple different wireless communications protocols. The wireless transceiver of the mobile device 120 can be configured to send data to and/or receive data from other mobile devices 120, the wireless transceivers 115, and/or one or more wireless base stations 140.

The mobile device 120 can be configured to include a Global Navigation Satellite System (GNSS) receiver configured to receive and measure signals from one or more satellites 170, such as satellites 170a and 170b, and to obtain pseudo-range measurements for the satellites 170. Satellites 170 may be part of a Global Navigation Satellite System (GNSS), which may be the United States Global Positioning System (GPS), the European Galileo system, the Russian GLONASS system, or some other GNSS. The GNSS receiver may also be configured to detect and receive signals from satellites 170 belonging to more than one GNSS system. For example, satellite 170a could belong to the GPS system while the satellite 170b could belong to the Galileo system. While the example network architecture illustrated herein illustrates only two satellites 170, other implementations may have more or less satellites available, may have satellites associated with one or more GNSS system, and the number of satellites visible to the mobile device 120 may depend upon the current geographical location of the mobile devices and the orbits of the satellites 170.

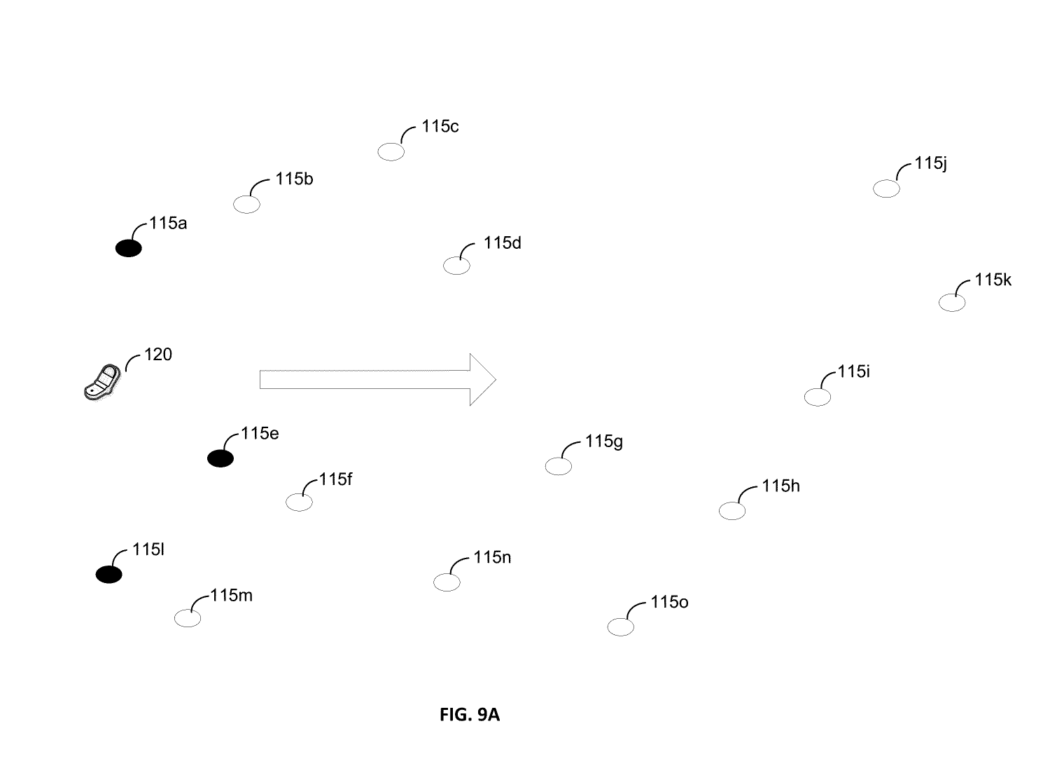

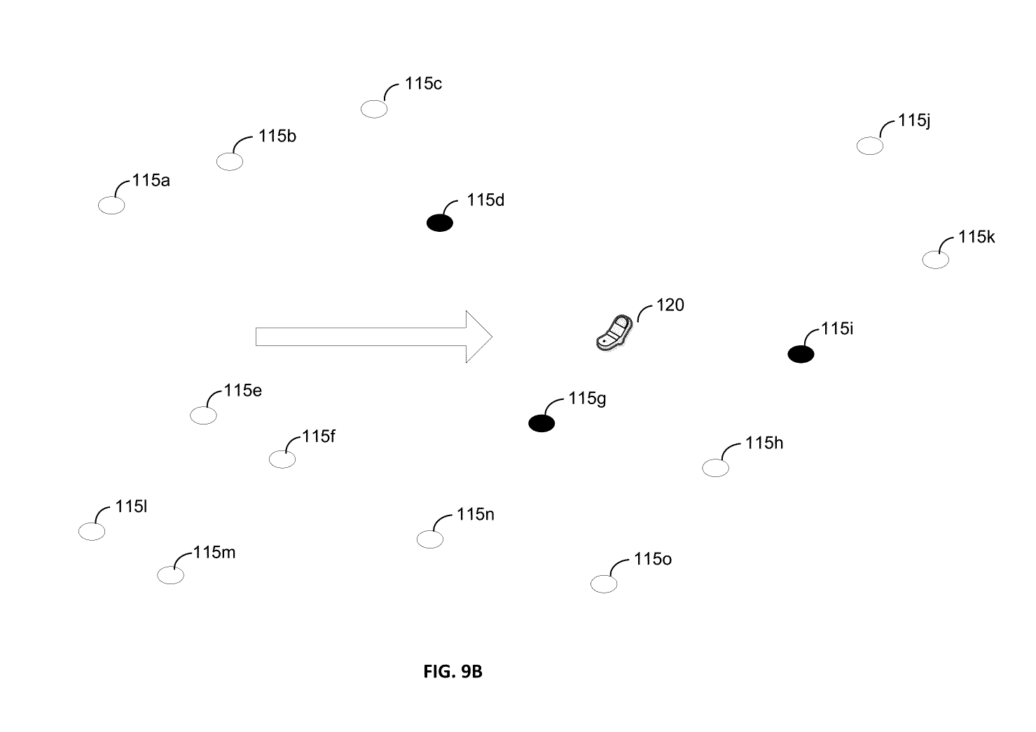

The mobile device 120 may also measure signals from one or more wireless base stations or wireless access points, such as the terrestrial wireless transceivers 115 and the macrocell base station 140, and obtain timing measurements (e.g., for time of arrival (TOA) or observed time difference of arrival (OTDOA)), signal strength measurements (e.g., Receive Signal Strength Indication (RSSI)), and/or signal quality measurements for the wireless base stations. The pseudo-range measurements, timing measurements, signal strength measurements, and/or signal quality measurements may be used to derive a location estimate for the mobile device 120. A location estimate may also be referred to as a position estimate, a position fix, etc. Two terrestrial wireless transceivers are illustrated in this example: 115a and 115b. However, in other implementations, more or less wireless transceivers 115 may be included. For example, the network environments illustrated in FIGS. 9A and 9B include more wireless transceivers 115 to illustrate specific aspects of the techniques disclosed herein. The mobile device 120 can also be configured to use a combination of signals from one or more of the satellites 170, the macrocell base station 140, and/or the wireless transceivers 115 to determine a position of the mobile device 120.

Each of the wireless transceivers 115 can comprise a WLAN wireless access point configured to operate using the IEEE 802.11 wireless communication standards. But, in some implementations some or all of the wireless transceivers 115 may be configured to utilize other wireless communications protocols, and some network environments may include a more than one type of wireless transceiver 115. The terrestrial wireless transceiver 115 can be connected to network 110 via a backhaul connection that provides a broadband connection to the network 110. The network 110 may be the Internet and/or a combination of one or more networks. For example, the terrestrial wireless transceiver 115 may be connected to a DSL modem or a cable modem, depending upon the type of broadband service being used in that particular implementation. A wireless transceiver 115 can be associated with a mobile communication network provider and can be configured to communicate with the mobile communication network provider's network (not shown) via the network 110. The coverage area of the a wireless transceiver 115 may overlap with that of one or more macrocell base stations, such as macrocell base station 140, or that of one or more other terrestrial transceivers.

The wireless base station 140 can be configured to provide wireless network connectivity to a plurality of mobile devices 120. The wireless base station 140 may comprise a macrocell base station or other type of base station. The wireless base station 140 may have a much larger coverage area than the terrestrial wireless transceiver 115 or may be a terrestrial transceiver that provides a coverage area that is of a similar size or of a smaller size than the coverage area provided by the terrestrial wireless transceiver 115. Wireless base station 140 can be configured to communicate using one or more wireless communications protocols. While the example illustrated in FIG. 1 includes on a single wireless base station 140, in other implementations the network environment is likely to include more than wireless base station 140 which have coverage areas that may overlap at least in part.

The location server 160 can be configured to provide location services to the mobile device 120. For example, the location server 160 can be configured to provide almanac information and/or other information that the mobile device 120 can use to determine the position of the mobile device 120. The location server 160 can also be configured to assist the mobile device 120 in determining the position of the mobile device 120. For example, the location server 160 can be configured to receive signal measurements of signals received at the mobile device 120 from wireless transceivers 115 and/or wireless base stations 140 and to determine a position of the mobile device 120 based on those signals.

The example network configuration illustrated in FIG. 1 is merely an example of one possible configuration of a network in which the techniques disclosed herein may be implemented. Other network configurations may include additional elements not illustrated in FIG. 1 and the various components may be interconnected in a different configuration than what is shown in FIG. 1.

### Example Hardware

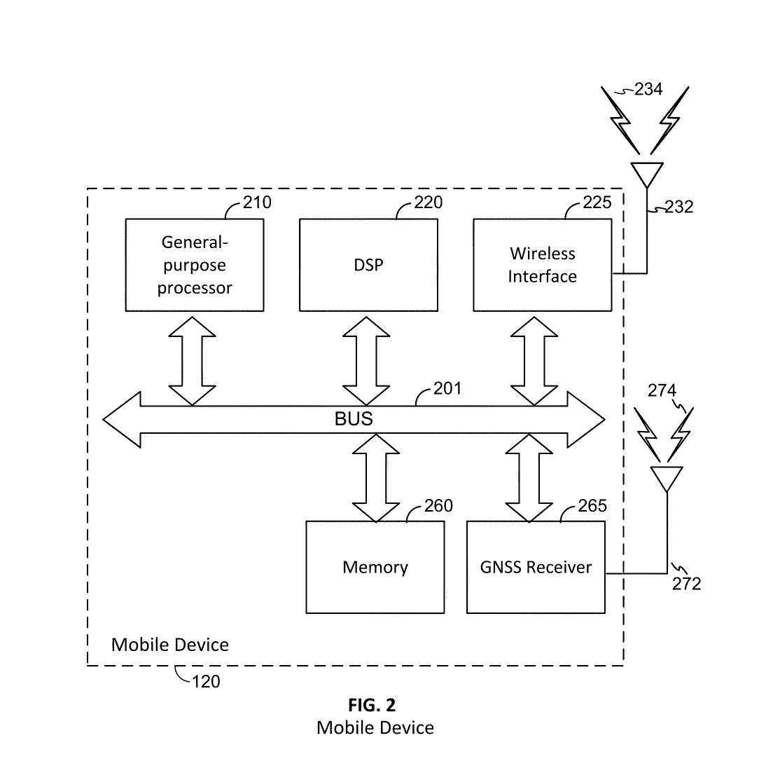

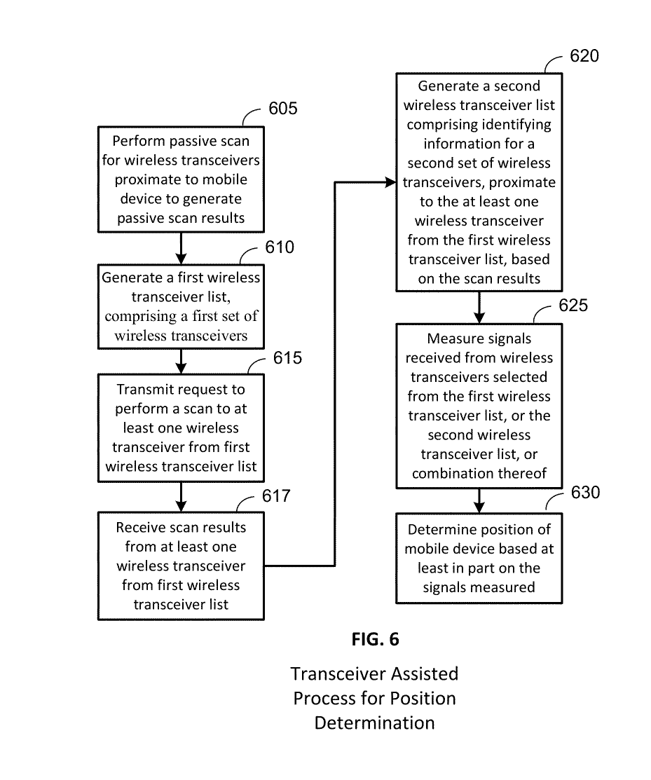

FIG. 2 is a block diagram of a mobile device that can be used to implement the mobile device 120 illustrated in FIG. 1. The mobile device 120 can be used to implement, at least in part, the processes illustrated in FIGS. 6-8.

The mobile device 120 comprises a computer system including a general-purpose processor 210, a digital signal processor (DSP) 220, a wireless interface 225, a GNSS interface 265, and a non-transitory memory 260, connected to each other by a bus 201. Other implementations of the mobile device 120 may include additional elements not illustrated in the example implementation of FIG. 2 and/or may not include all of the elements illustrated in the example embodiment illustrated in FIG. 2. For example, some implementations of the mobile device 120 may not include the GNSS interface 265.

The wireless interface 225 can include a wireless receiver, transmitter, transceiver, and/or other elements that enable the mobile device 120 to send and/or receive data using WWAN, WLAN, and/or other wireless communication protocols. The wireless interface 225 can comprise one or more multi-mode modems capable of transmitting and receiving wireless signals using multiple wireless communications standards. The wireless interface 225 is connected by a line 232 to an antenna 234 for sending and receiving communications to/from the wireless transceivers 115, the wireless base station 140, and/or other wireless devices configured to communicate using wireless communication protocols. While the mobile device 120 illustrated in FIG. 2 comprises a single wireless interface 225 and a single antenna 234, other implementations of the mobile device 120 can include multiple wireless interfaces 225 and/or multiple antennas 234.

The GNSS interface 265 can include a wireless receiver and/or other elements that enable the mobile device 120 to receive signals from transmitters associated with one or more GNSS systems. The GNSS interface 265 is connected by a line 272 to an antenna 274 for receiving signals from the GNSS transmitters, such as the satellites 170 illustrated in FIG. 1. The mobile device 120 can be configured to use signals received from satellites and other GNSS transmitters to determine a position of the mobile device 120. The mobile device 120 can also be configured to use the signals received from the satellites and other transmitters associated with the GNSS systems in conjunction with signals received from wireless transceivers 115 and/or wireless base stations 140 to determine a position of the mobile device 120.

The DSP 220 can be configured to process signals received from the wireless interface 225 and/or the GNSS interface 265 and may be configured to process signals for or in conjunction with one or more modules implemented as processor-readable, processor-executable software code stored in memory 260 and/or can be configured process signals in conjunction with the processor 210.

The processor 210 can be an intelligent device, e.g., a personal computer central processing unit (CPU) such as those made by Intel® Corporation or AMD®, a microcontroller, an application specific integrated circuit (ASIC), etc. The memory 260 is a non-transitory storage device that can include random access memory (RAM), read-only memory (ROM), or a combination thereof. The memory 260 can store processor-readable, processor-executable software code containing instructions for controlling the processor 210 to perform functions described herein (although the description may read that the software performs the function(s)). The software can be loaded onto the memory 260 by being downloaded via a network connection, uploaded from a disk, etc. Further, the software may not be directly executable, e.g., requiring compiling before execution.

The software in the memory 260 is configured to enable the processor 210 to perform various actions, including implementing sending and/or receiving data from the wireless transceivers 115, the wireless base station 140, other mobile devices 120, and/or other devices configured for wireless communication.

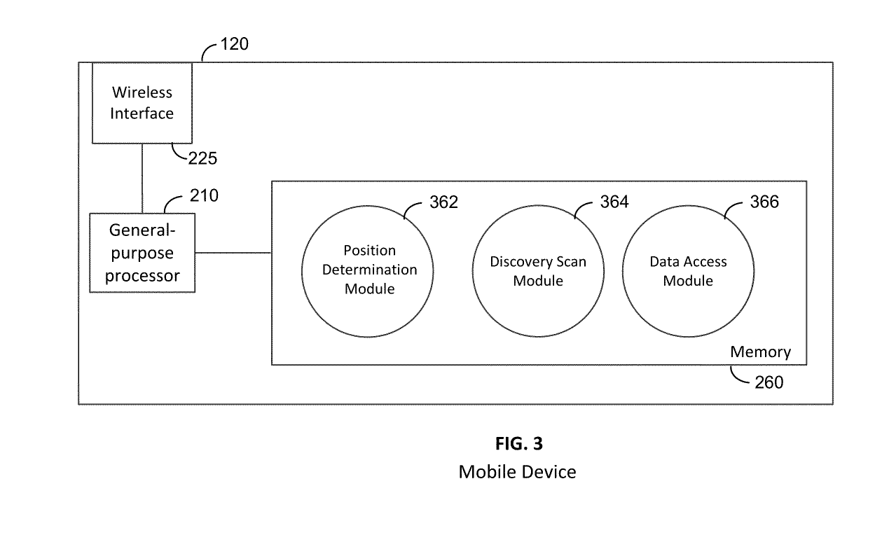

FIG. 3 is a functional block diagram of the mobile device 120 illustrated in FIG. 2 that illustrates functional modules of a memory 260 shown in FIG. 2. For example, the mobile device 120 can include a position determination module 362, a discovery scan module 364, and a data access module 366. The mobile device 120 may also include one or more additional functional modules that provide other functionality to the mobile device 120. The mobile device 120 illustrated in FIGS. 2 and 3 can be used to implement the mobile device 120 associated with the processes illustrated in FIGS. 6-8.

The position determination module 362 can be configured to determine a position of the mobile device 120. The position determination module 362 can provide means for determining the position of the mobile device based at least in part on the signal measurements. For example, the position determination module 362 can be configured to receive pseudorange data from the GNSS interface 265 and use the pseudorange data to determine a position of the mobile device 120. The position determination module 362 can also be configured to request and receive assistance data from a network entity, such as the location server 160. The position determination module 362 can also be configured to use measurements of signals received from wireless base stations 140 and/or wireless transceivers 115 to determine a position of the mobile device 120. The position determination module 362 can also be configured to use pseudorange information from the GNSS interface 265 and measurements of signals received from wireless base stations 140 and/or wireless transceivers 115 to determine a position of the mobile device 120. The position determination module 362 can be configured to determine the position of the mobile device in response to a request from an application running on the mobile device, in response to an external entity (such as the location server) requesting a position of the mobile device, or in response to a request from another module of the mobile device. The processor 210 can also provide means for implementing the various modules discussed herein and may operate in conjunction. Furthermore, the wireless interface 225 can provide means for sending and/or receiving data and/or requests, except for GNSS signal data for which the GNSS receiver 265 can provide means for receiving such data.

The discovery scan module 364 can be configured to perform active and/or passive scans for wireless transceivers proximate to the mobile device 120. The discovery scan module 364 can be configured to identify wireless transceivers 115 proximate to the mobile device 120 that are configured to receive requests from the mobile device 120 to perform active and/or passive scans for other wireless transceivers 115 proximate to the wireless transceivers 115 and to provide the results of the scans to the mobile device 120.

The discovery scan module 364 can be configured to maintain a first wireless transceiver list (also referred to herein as a list of prime transmitters or preferred wireless transceivers list) and can also be configured to maintain a list of channels associated with the wireless transceivers on the first wireless transceiver list. The fires wireless transceiver list can include wireless transceivers 115 proximate to the mobile device that have a signal strength over a predetermined threshold. The discovery scan module 364 can be configured to rank the wireless transceivers 115 based on signal strength of signals received at the mobile device 120 from each of the wireless transceivers 115 and/or on other criteria. For example, the discovery scan module 364 can be configured to rank the wireless transceivers 115 proximate to the mobile device 120 based on Received Signal Strength Indication (RSSI) and/or other measurement of the signal strength of signals received from the wireless transceivers 115 at the mobile device 120. The discovery scan module 364 can be configured to include all wireless transceivers 115 on the first wireless transceiver list that have a signal strength measurement that exceeds the predetermined threshold amount. The discovery scan module 364 can be configured to limit the size of the first wireless transceiver list to a predetermined number of wireless transceivers 115. The discovery scan module 364 can also be configured to maintain the first wireless transceiver list organized by channel. For example, the wireless transceivers 115 can be configured to transmit on more than one frequency band and can be configured to transmit on one or more channels within the frequency band. The discovery scan module 364 can be configured to maintain the first wireless transceiver list organized by channel and can be configured to include up to a predetermined number of wireless transceivers 115 for each channel on the first wireless transceiver list.

FIGS. 9A and 9B illustrate how the discovery scan module 364 can be configured to dynamically update the first wireless transceiver list as the mobile device 120 moves through an indoor environment. FIG. 9A illustrates the mobile device at a first position within an indoor environment, and FIG. 9B illustrates the mobile device at a second position within the indoor environment. As the mobile device 120 moves from the first position to the second position the wireless transceivers 115 proximate to the mobile device 120 can change. For example, at the first position, the mobile device is proximate to wireless transceivers 115a, 115e, and 1151, and the discovery scan module 364 selects these three wireless transceivers from the plurality of wireless transceivers proximate to the mobile device to be include in the first wireless transceiver list. As the mobile device 120 moves to the second position, the discovery scan module 364 can select a new set of wireless transceivers to include on the first wireless transceiver list. In this example, at the second position, the wireless transceivers 115a, 115e, and 1151 have been selected by the discovery scan module 364. As a mobile device 120 moves through an indoor environment, different wireless transceivers 115 may be selected by the discovery scan module 364 for the first wireless transceiver list using the various techniques discussed above. The discovery scan module 364 may drop one or more wireless transceivers from the first wireless transceiver list and/or add one or more wireless transceivers from the first wireless transceiver list as the mobile device 120 moves and signal conditions change due to changing proximity and/or environmental conditions.

The discovery scan module 364 can be configured to send a request to one or more of the wireless transceivers 115 included on the first wireless transceiver list to perform an active and/or passive scan for wireless transceivers 115 on behalf of the mobile device 120. The discovery scan module 364 can be configured to send the request in the form of a WLAN Radio Measurement frame to the one or more wireless transceivers 115. The wireless transceivers 115 receiving the request can be configured to perform the requested active and/or passive scan and to provide the results of the scan to the mobile device 120. The scan request can specify one or more channels on which the mobile device 120 is requesting that the one or more wireless transceivers 115 perform the active and/or passive scans. The assisted discovery techniques implemented by the discovery scan module can allow the mobile device 120 to perform a more extensive scan for wireless transceivers 115 proximate to the mobile device 120 than may have been possible using conventional discovery scan techniques in which the mobile device 120 performs the scans itself. Scanning across multiple channels for signals from the wireless transceivers 115 can consume significant amounts of processing resources and wireless interface resources. Scanning can also consume limited power resources where the mobile device 120 is not receiving power from an external power source and is instead operating on an internal battery source, such as a battery.

A passive scan is a scan across one or more channels in which wireless transceivers 115 may be operating in which the discovery scan module 364 or a wireless transceiver 115 performing a scan on behalf of the mobile device 120 listens for transmissions from one or more wireless transceivers 115. The transmissions from the wireless transceivers 115 can be used to identify the wireless transceiver 115 making the transmission. For example, where a wireless transceiver 115 is configured to operate using one of the wireless local area network (WLAN) specifications such as the IEEE 802.11 family of wireless communication protocols, the discovery scan module 364 or the wireless transceiver 115 performing a scan on behalf of the mobile device 120 can be configured to listen for beacons and/or probe responses transmitted by the wireless transceivers 115 proximate to the mobile device 120 or the wireless transceiver 115 performing the scan on behalf of the mobile device 120. During a passive scan, the mobile device 120 or the wireless transceiver 115 performing the scan on behalf of the mobile device 120 does not transmit probe requests or other transmissions to elicit a response from the wireless transceivers 115 proximate to the device conducting the passive scan. One risk associated with passive scanning is that wireless transceivers 115 that do not broadcast a beacon or other indication of their presence could be missed by the device conducting the passive scan.

An active scan is a scan across one or more channels in which wireless transceivers 115 may be operating in which the discovery scan module 364 or a wireless transceiver 115 performing a scan on behalf of the mobile device 120 actively solicits wireless transceivers 115 for responses in addition to listening for transmissions from one or more wireless transceivers 115. A device conducting an active scan can be configured to transmit probe requests that include a null SSID name (a probe-any request) to solicit responses from all wireless transceivers 115 configured to receive and respond to such probe requests. Active scanning can consume more power than passive scans because the device conducting the scan is transmitting requests as well as listening for beacons and/or probe request responses from wireless transceivers 115 proximate to the device conducting the active scan.

The discovery scan module 364 can be configured to perform a passive scan for one or more wireless transceiver 115 proximate to the mobile device and to send a request to the one or more wireless transceivers 115 proximate to the mobile device to conduct an passive and/or active scan for other wireless transceivers 115 on behalf of the mobile device 120. This assisted discovery approach can consume less power and processing resources on the mobile device 120, which may have a limited power supply provided by a battery and may have limited processing power in order to reduce power consumption and extend battery life. The assisted discovery approach can also speed up the discovery process, because the mobile device 120 can request that multiple wireless transceivers 115 perform discovery scans in parallel with one another. The discovery scan module 364 can also be configured to perform scans in parallel with one or more wireless transceivers 115 in order to obtain scan results quicker than would be possible if the mobile device 120 performed similar scans.

The discovery scan module 364 can be configured to process scan reports provided by wireless transceivers 115 and to update information that identifies wireless transceivers proximate to the mobile device 120. The wireless transceiver information can be stored in the memory 260 and can be accessed and/or updated by the discovery scan module 364 via the data access module 366. The position determination module 362 can be configured to use the wireless transceiver information to determine the location of the mobile device. For example, the position determination module 362 can be configured to select wireless transceivers 115 from the list of wireless transceivers 115 proximate to the mobile device 120 and to take signal measurements that the position determination module 362 can use to determine a position of the mobile device 120. The position determination module 362 can also be configured to send the signal measurements to a location server or other network entity that is configured to determine the position of the mobile device and/or provide assistance data to the mobile device 120 that the mobile device 120 can use to determine the position of the mobile device 120.

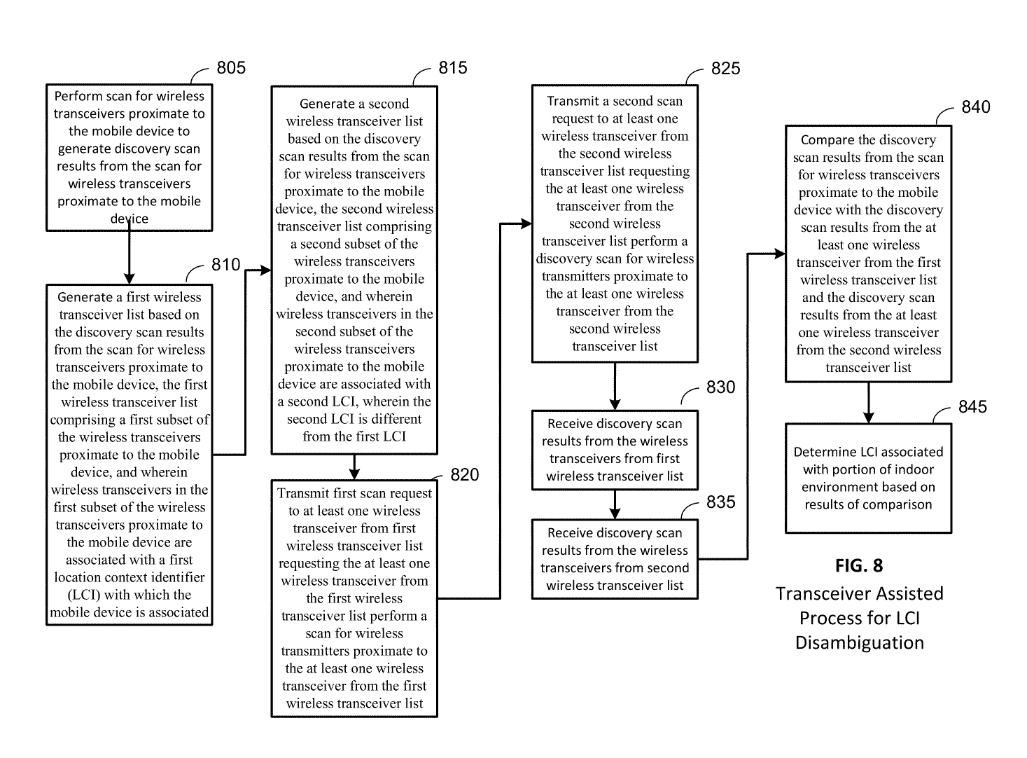

The discovery scan module 364 can also be configured to perform location context identifier (LCI) disambiguation using the technique illustrated in FIG. 8. The position determination module 362 may, under some circumstances, be unable to determine whether the mobile device 120 is located in a portion of an indoor environment associated with a first LCI or a second LCI. In some situations, that position determination module 362 may need to disambiguate between more than two LCIs. The position determination module 362 can be configured to send a request to the discovery scan module 364 to perform an LCI disambiguation using the assisted discovery techniques disclosed herein. The discovery scan module 364 can be configured to use an assisted scanning technique to obtain information identifying wireless transceivers 115 proximate to the mobile device 120, and the discovery scan module 364 can be configured to conduct a scan for wireless transceivers 115 proximate to the mobile device 120. The discovery scan module 364 can be configured to compare the results obtained from the assisted scan with the results obtained from the scan conducted by the mobile device 120 in an attempt to disambiguate which LCI the mobile device is associated.

The data access module 366 can be configured to store data in the memory 260 and/or other data storage devices associated with the mobile device 120. The data access module 366 can also be configured to access data in the memory 260 and/or other data storage devices associated with the mobile device 120. The data access module 366 can be configured to receive requests from other modules and/or components of the mobile device 120 and to store and/or access data stored in the memory 260 and/or other data storage devices associated with the mobile device 120.

The discovery scan module 364 in conjunction with the wireless interface 225 can provide means for performing a passive scan for wireless transceivers proximate to the mobile device to generate passive scan results. The discovery scan module 364 can provide means for generating a first wireless transceiver list, comprising a first set of wireless transceivers. The discovery scan module 364 in conjunction with the wireless interface 225 can provide means for transmitting a request to at least one wireless transceiver from the first wireless transceiver list requesting that the at least one wireless transceiver perform a scan for wireless transceivers and means for receiving scan results from the at least one wireless transceiver from the first wireless transceiver list. The discovery scan module 364 can provide means for generating a second wireless transceiver list comprising identifying information for a second set of wireless transceivers, proximate to the at least one wireless transceiver. The discovery scan module 364 in conjunction with the wireless interface 225 can provide means for measuring signals received from wireless transceivers selected from the first wireless transceiver list, or the second wireless transceiver list, or combination thereof. The discovery scan module 364 and/or the position determination module 362 can provide means for determining the position of the mobile device based at least in part on the signals measured. The discovery scan module 364 can also provide means for periodically performing additional passive scans for the wireless transceivers proximate to the mobile device and means for updating the first wireless transceiver list based on results of the additional passive scans. The means for updating the first wireless transceiver list provided by the discovery scan module 364 can include means for removing one or more wireless transceivers from the first wireless transceiver list responsive to a signal strength associated with each of the one or more wireless transceivers from the first wireless transceiver list falling below a first predetermined threshold. The means for updating the first wireless transceiver list provided by the discovery scan module 364 can include means for adding one or more wireless transceivers that are currently not on the first wireless transceiver list to the first wireless transceiver list responsive to the signal strength associated with each of the one or more wireless transceivers that are currently not on the first wireless transceiver list exceeding a second predetermined threshold.

The discovery scan module 364 can also provide means for performing a scan for wireless transceivers proximate to the mobile device to generate discovery scan results from the scan for wireless transceivers proximate to the mobile device and means for generating a first wireless transceiver list based on the discovery scan results from the scan for wireless transceivers proximate to the mobile device, where the first wireless transceiver list includes a first subset of the wireless transceivers proximate to the mobile device, and where the wireless transceivers in the first subset of the wireless transceivers proximate to the mobile device are associated with a first location context identifier (LCI) with which the mobile device is associated. The discovery scan module 364 can also provide means for generating a second wireless transceiver list based on the first discovery scan results, where the second wireless transceiver list includes a second subset of the wireless transceivers proximate to the mobile device, and where the wireless transceivers in the second subset of the wireless transceivers proximate to the mobile device are associated with a second LCI that is different from the first LCI. The discovery scan module 364 in conjunction with the wireless interface 225 can also provide means for transmitting a first scan request to at least one wireless transceiver from the first wireless transceiver list requesting the at least one wireless transceiver from the first wireless transceiver list perform a scan for wireless transmitters proximate to the at least one wireless transceiver from the first wireless transceiver list and means for transmitting a second scan request to at least one wireless transceiver from the second wireless transceiver list requesting the at least one wireless transceiver from the second wireless transceiver list perform a discovery scan for wireless transmitters proximate to the at least one wireless transceiver from the second wireless transceiver list. The discovery scan module 364 in conjunction with the wireless interface 225 can also provide means for receiving discovery scan results from the at least one wireless transceiver from the first wireless transceiver list and means for receiving discovery scan results from the at least one wireless transceiver from the second wireless transceiver list. The discovery scan module 364 can also provide means for comparing the discovery scan results from the scan for wireless transceivers proximate to the mobile device with the discovery scan results from the at least one wireless transceiver from the first wireless transceiver list and the discovery scan results from the at least one wireless transceiver from the second wireless transceiver list. The discovery scan module 364 and/or the position determination module 362 can also provide means for determining an LCI associated with a portion of an indoor environment in which the mobile device is located based at least in part on results of comparison. The first scan request, the second scan request, or both can be a request to perform an active scan or a passive scan. The discovery scan module 364 can also provide means for selecting the LCI from a plurality of LCIs based on a number of wireless transceivers included in the discovery scan results also appearing in the discovery scan results associated with the LCI that is selected. The discovery scan module 364 can also provide means for determining an LCI associated with a portion of an indoor environment in which the mobile device is located based at least in part on results of comparison further comprises selecting the LCI based on a number of wireless transceivers included in the discovery scan results from the scan for wireless transceivers proximate to the mobile device, the discovery scan results from the at least one wireless transceiver from the first wireless transceiver list, and the discovery scan results from the at least one wireless transceiver from the second wireless transceiver list associated with the LCI. The discovery scan module 364 can provide means for selecting the LCI based on a number of wireless transceivers included in the discovery scan results conducted by the wireless transceiver that were included in the discovery scan results from the at least one wireless transceiver from the first wireless transceiver list, which includes wireless transceivers associated with the current LCI with which the mobile device 120 is associated, and based on a number of wireless transceivers included in the discovery scan results conducted by the wireless transceiver that were included in the discovery scan results from the at least one wireless transceiver from the second wireless transceiver list, which includes wireless transceivers not associated with the current LCI with which the mobile device 120 is associated. If more wireless transceivers identified by the scan conducted by the mobile device match those associated with the current LCI, the discovery scan module can be configured to continue associating the current LCI with the mobile device 120. Otherwise, the discovery scan module can be configured to associate a new LCI based on a number of matches of wireless transceivers included in the discovery scan result conducted by the mobile device 120 and discovery scan results associated with wireless transceivers included in the second wireless transceiver list.

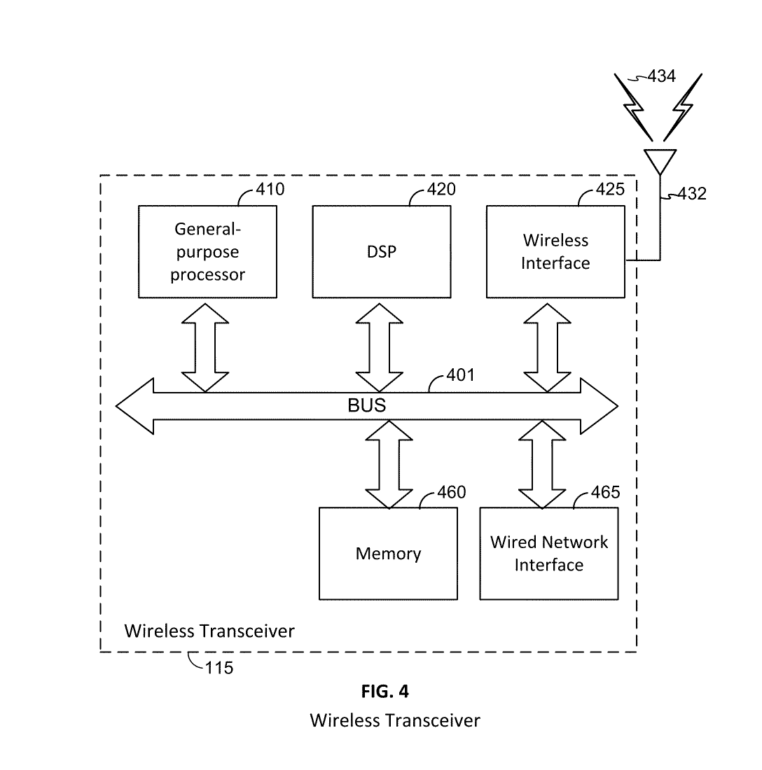

FIG. 4 is a block diagram of a wireless transceiver that can be used to implement the wireless transceivers 115 illustrated in FIG. 1. The wireless transceiver 115 can be used to implement, at least in part, the processes illustrated in FIGS. 6-8.

The wireless transceiver 115 comprises a computer system including a general-purpose processor 410, a digital signal processor (DSP) 420, a wireless interface 425, a wired network interface 465, and a non-transitory memory 460, connected to each other by a bus 401. Other implementations of the wireless transceiver 115 may include additional elements not illustrated in the example implementation of FIG. 4 and/or may not include all of the elements illustrated in the example embodiment illustrated in FIG. 4. For example, some implementations of the wireless transceiver 115 may not include the wired network interface 465.

The wireless interface 425 can include a wireless receiver, transmitter, transceiver, and/or other elements that enable the wireless interface 425 to send and/or receive data using WWAN, WLAN, and/or other wireless communication protocols. The wireless interface 425 can comprise one or more multi-mode modems capable of transmitting and receiving wireless signals using multiple wireless communications standards. The wireless interface 425 is connected by a line 432 to an antenna 434 for sending and receiving communications to/from the mobile device 120, the wireless base station 140, and/or other wireless devices configured to communicate using wireless communication protocols. While the wireless transceiver 115 illustrated in FIG. 4 comprises a single wireless interface 425 and a single antenna 434, other implementations of the wireless transceiver 115 can include multiple wireless interfaces 425 and/or multiple antennas 434. In some implementations, the wireless transceiver 115 can be configured to provide wireless network access to the mobile device 120 and/or other wireless devices. For example, the wireless transceiver 115 can be configured to operate as a WLAN access point that can provide wireless connectivity to the mobile device 120 and/or other devices configured to communicate using WLAN wireless communication protocols. In some implementations, the wireless transceiver 115 can be configured to provide network connectivity to the mobile device 120 using a first wireless protocol and to connect to the Internet or other network via a second wireless protocol. For example, the wireless transceiver 115 can be configured to connect to the network 110 via a WWAN wireless communication protocol and to connect to the mobile device 120 using a WLAN wireless communication protocol.

The wireless transceiver 115 can also include wired network interface 465 that provides wired network connectivity to the network 110. For example, the wired network connection can comprise a wired broadband connection, and the wired network interface 465 can be configured to comprise or connect to a cable modem and/or a Digital Subscriber Line (DSL) modem. The wired network interface 465 can be configured to send and/or receive data via the wired network connection.

The DSP 420 can be configured to process signals received from the wireless interface 425 and/or the wired network interface 465 and may be configured to process signals for or in conjunction with one or more modules implemented as processor-readable, processor-executable software code stored in memory 460 and/or can be configured process signals in conjunction with the processor 410.

The processor 410 can be an intelligent device, e.g., a personal computer central processing unit (CPU) such as those made by Intel® Corporation or AMD®, a microcontroller, an application specific integrated circuit (ASIC), etc. The memory 460 is a non-transitory storage device that can include random access memory (RAM), read-only memory (ROM), or a combination thereof. The memory 460 can store processor-readable, processor-executable software code containing instructions for controlling the processor 410 to perform functions described herein (although the description may read that the software performs the function(s)). The software can be loaded onto the memory 460 by being downloaded via a network connection, uploaded from a disk, etc. Further, the software may not be directly executable, e.g., requiring compiling before execution.

The software in the memory 460 is configured to enable the processor 410 to perform various actions, including implementing sending and/or receiving data from the mobile device 120, and/or other devices configured for wireless communication.

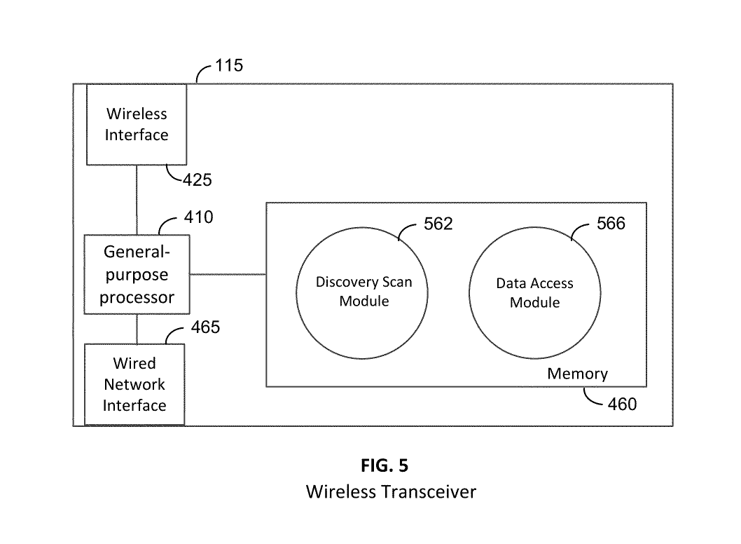

FIG. 5 is a functional block diagram of the wireless transceiver 115 illustrated in FIG. 4 that illustrates functional modules of a memory 460 shown in FIG. 4. For example, the wireless transceiver 115 can include a discovery scan module 562, and a data access module 566. The wireless transceiver 115 may also include one or more additional functional modules that provide other functionality to the wireless transceiver 115. The wireless transceiver 115 illustrated in FIGS. 4 and 5 can be used to implement the wireless transceiver 115 associated with the processes illustrated in FIGS. 6-8.

The discovery scan module 562 can be configured to receive requests to perform scans for wireless transceivers proximate to the wireless transceiver 115 from the mobile device 120. The discovery scan module 562 can be configured to wirelessly receive the request from the mobile device 120. In some implementations, the request from the mobile device 120 can be in the form of a WLAN Radio Measurement frame. The request can specify a scan type to be performed and the discovery scan module 562 can be configured to operate the wireless interface 425 to scan for other wireless transceivers proximate to the wireless transceiver 115 according to the parameters defined in the request. For example, the request can specify whether an active or a passive scan is being requested. The discovery scan module 562 can perform the requested active and/or passive scan and can transmit the results of the scan to the mobile device 120 via the wireless connection between the wireless transceiver 115 and the mobile device 120. The discovery scan module 562 can be configured to perform the scan for other wireless transceivers on multiple channels. The scan request can specify one or more channels on which the wireless transceiver 115 is to perform the active and/or passive scans.

The data access module 566 can be configured to store data in the memory 460 and/or other data storage devices associated with the wireless transceiver 115. The data access module 566 can also be configured to access data in the memory 460 and/or other data storage devices associated with the wireless transceiver 115. The data access module 566 can be configured to receive requests from other modules and/or components of the wireless transceiver 115 and to store and/or access data stored in the memory 460 and/or other data storage devices associated with the wireless transceiver 115.

### Example Implementations

FIG. 6 is a flow diagram of a process for determining the position of a mobile device 120 using the passive scanning techniques discussed herein. The process illustrated in FIG. 6 can be implemented using the mobile device 120 illustrated in FIG. 1. The discovery scan module 364 of the mobile device 120 provides means for performing the various stages included in the process illustrated in FIG. 6 unless otherwise specified.

A passive scan for wireless transceivers proximate to the mobile device 120 can be performed to generate passive scan results (stage 605). The discovery scan module 364 of the mobile device 120 can be configured to perform a passive scan for a first set of wireless transceivers proximate to the mobile device 120. The discovery scan module 364 can be configured to operate the wireless interface 225 of the mobile device 120 to detect signals from one or more wireless transceivers 115 proximate to the mobile device 120. The discovery scan module 364 can be configured to conduct the passive scan across one or more channels. The area in which the mobile device 120 is located may include multiple wireless transceivers 115 and these wireless transceivers may be operating on more than one channel. The discovery scan module 364 can be configured to access channel information that indicates which channels the wireless transceivers 115 are most likely to be operating on in the area which the mobile device 120 is located. The discovery scan module 364 can be configured to obtain a coarse position estimate from the position determination module 362 which the discovery scan module 364 can use to select channel information appropriate for the geographic area in which the mobile device is located. The position determination module 362 can also be configured to provide a coarse position estimate based on previously determined position information for the mobile device 120. The channel information can be stored in the memory 260 of the mobile device 120. The discovery scan module 364 can also be configured to obtain the channel information from the location server 160 or another network entity. In some implementations, the channel information may be provided by a mobile network carrier associated with the mobile device 120 at the time that the mobile device is configured to operate with the mobile network carrier's network.

When conducting the passive scan, the discovery scan module 364 can be configured to operate the wireless interface 225 to listen for transmissions from wireless transceivers 115 proximate to the mobile device 120. For example, the discovery scan module 364 can be configured to operate the wireless interface 225 to listen for beacons and/or probe responses where at least a portion of the wireless transceivers 115 comprise WLAN wireless access points. The discovery scan module 364 can be configured to use the beacons, probe responses, and/or other signals transmitted by the wireless transceivers 115 to identify the wireless transceivers 115 transmitting the information. The discovery scan module 364 can also be configured to measure signal strength of the signals received from each of the wireless transceivers 115. For example, the discovery scan module 364 can be configured to measure the signal strength of signals received from the wireless transceivers 115 proximate to the mobile device 120 and to associate Received Signal Strength Indicator (RSSI) values with each of the wireless transceivers 115 from which signals were received.

A first wireless transceiver list that includes a first set of wireless transceivers can be generated based on the passive scan results (stage 610). The discovery scan module 364 can be configured to generate a first wireless transceiver list based on the results of the passive scan. The discovery scan module 364 can be configured to select one or more wireless transceivers 115 to add to the first wireless transceiver list based on signal measurements. For example, the discovery scan module 364 can be configured to rank the wireless transceivers 115 from which signals were received by a signal strength value associated with each of the wireless transceivers 115. The discovery scan module 364 can be configured to select up to a predetermined number of wireless transceivers 115 to include on the first wireless transceiver list. The discovery scan module 364 can also be configured to include all of the wireless transceivers 115 from which signals were received.

A request can be transmitted to at least one wireless transceiver from the first wireless transceiver list requesting that the at least one wireless transceiver perform a scan (stage 615). The discovery scan module 364 can be configured to select one or more of the wireless transceivers from the first wireless transceiver list and send a request to the each of the selected wireless transceivers 115 to perform a scan for other wireless transceivers 115 on behalf of the mobile device 120. The discovery scan module 364 can be configured to send the request to the selected wireless transceiver or wireless transceivers 115 in the form of a WLAN Radio Measurement frame. The request can specify a scan type to be performed. For example, the request can specify whether an active or a passive scan is being requested. The wireless transceivers 115 receiving the request can be configured to perform the requested active and/or passive scan and to provide the results of the scan to the mobile device 120. The scan request can specify one or more channels on which the mobile device 120 is requesting that the one or more wireless transceivers 115 perform the active and/or passive scans. The discovery scan module 364 can be configured to select multiple wireless transceivers 115 to perform multiple scans in parallel with one another. The scans can be conducted on multiple channels at once and can significantly decrease the amount of time that would be required to conduct a discovery scan. Furthermore, the discovery scans conducted by the wireless transceivers 115 may also be more accurate, as the wireless transceivers typically operate a higher transmit and receive power than the mobile device 120 and thus be more sensitive than the mobile device 120 providing more accurate results. Furthermore, wireless transceivers 115 that have switched to a different channel or those do not broadcast an SSID or other identifier may also be detected more quickly as the discovery scan can be conducted across multiple channels at once by the wireless transceivers 115.

Scan results can be received from the at least one wireless transceiver from the first wireless transceiver list (stage 617). The discovery scan module 364 can be configured to receive discovery scan results via the wireless interface 225 of the mobile device 120. The discovery scan results from the at least one wireless transceiver 115 from the first wireless transceiver list can include information that identifies one or more other wireless transceivers 115 proximate to at least one wireless transceiver 115 from the first wireless transceiver list. In some implementations, the scan results comprise one or more WLAN Radio Measurement Report frames. The scan results can include information such as the channel set and/or channel number for which the scan results apply, measurement start and end times and/or measurement duration, and information identifying one or more wireless transceivers 115 from which signals were received during the scan. The scan results can also identify whether a passive or active scan was performed by the wireless transceiver 115 that conducted the scan.

A second wireless transceiver list comprising identifying information for a second set of wireless transceivers proximate to the at least one wireless transceiver from the first wireless transceiver list can be generated based on the scan results (stage 620). The discovery scan module 364 can be configured to generate the second wireless transceiver list based on the scan results received from the at least one wireless transceiver from the first wireless transceiver list. The discovery scan module 364 can be configured to include all of the wireless transceivers included in the scan results in the second wireless transceiver list. The discovery scan module 364 can also be configured to select a subset of the wireless transceivers included in the scan results to include in the second wireless transceiver list. For example, the discovery scan module 364 can be configured to select a subset of wireless transceivers 115 the scan results provided each of the wireless transceivers 115 from the first wireless transceiver list 115 from which scan results are received. The discovery scan module 364 can also be configured to select wireless transceivers 115 that are included in the scan results received from multiple wireless transceivers 115 from the first wireless transceiver list, because the selected wireless transceivers 115 are likely to be proximate to the mobile device 120.

Signals received from wireless transceivers from the first wireless transceiver list, the second wireless transceiver list, or a combination thereof can be measured to generate signal measurements (stage 625). In some implementations, the discovery scan module 364 can be configured to select all of the wireless transceivers from the first wireless transceiver list and the second wireless transceiver list and to collect signal measurements from those wireless transceivers 115 via the wireless interface 225 of the mobile device 120. The discovery scan module 364 can also be configured to select a subset of the wireless transceivers 115 from the first wireless transceiver list and/or the second wireless transceiver list from which signal measurements will be collected. For example, the discovery scan module 364 can be configured to obtain signal strength measurements, such as RSSI (received signal strength indication) measurements, timing measurements, such as RTT (round-trip time)) and/or time of arrival (TOA) measurements, or a combination thereof from the wireless transceivers from the first wireless transceiver list, the second wireless transceiver list, or a combination thereof can be measured to generate the signal measurements.

A position of the mobile device can be determined based at least in part on the signals measured (stage 630). The position determination module 362 can be configured to determine a position of the mobile device based on measurements of signals received from the selected wireless transceivers 115. For example, the position determination module 362 can be configured to determine a position of the mobile device 120 by performing trilateration using signal measurements. The position determination module 362 can be configured to use timing measurements and/or signal strength measurements to determine an estimate range from the wireless transceivers 115 from which the signal measurements have been obtained, and the position determination module 362 can use this information to determine an estimated position of the mobile device 120. The position determination module 362 can be configured to make use of GNSS information as well as the signal measurements obtained from the selected wireless transceivers to determine a position of the mobile device 120. For example, the GNSS receiver 265 of the mobile device may have obtained pseudorange measurements for one or more GNSS satellites but has obtained an insufficient number of pseudorange measurements to determine a position of the mobile device. However, the position determination module 362 can be configured to use the pseudorange measurements in addition to other information, such as the signal measurements from the selected wireless transceivers 115 to determine a position of the mobile device 120. The position determination module 362 can also be configured to send the signal measurements, range information derived therefrom, and/or pseudorange measurements to the location server 160, and the location server 160 can be configured to determine the position of the mobile device 120 and to send position information to the mobile device 120.

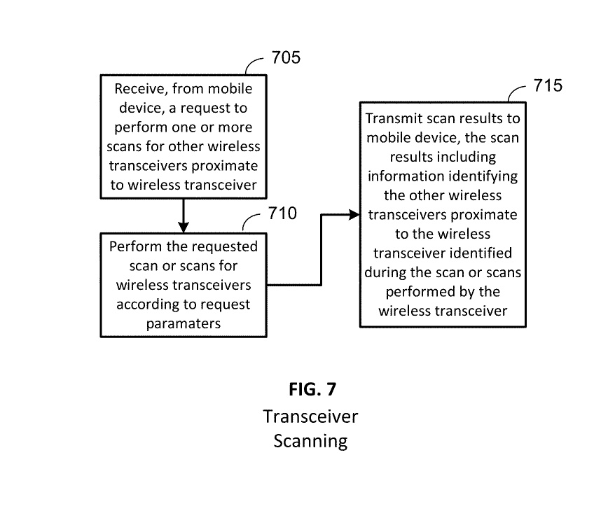

FIG. 7 is a flow diagram of a process for providing assistance data to a mobile device according. The process illustrated in FIG. 7 can be implemented by a wireless transceiver 115, such as those illustrated in FIG. 1. The process illustrated in FIG. 7 can be used by the wireless transceiver to perform a scan in response to receiving a request to perform a scan from a mobile device 120 and to provide the scan results to the mobile device 120.

A request to perform one or more scans for other wireless transceivers 115 proximate to the wireless transceiver 115 can be received (stage 705). The wireless transceiver 115 can receive the request from the mobile device 120 via a wireless connection between the wireless transceiver 115 and the mobile device 120. The request from the mobile device 120 can comprise a WLAN Radio Measurement frame that includes parameters that scan type to be performed and/or on which channels the discovery scan module 562 of the wireless transceiver 115 should scan for other wireless transceivers 115. For example, the request can specify whether an active or a passive scan is being requested.

The scan or scans can be performed according to the request parameters (stage 710). The request received from the mobile device 120 request that one or more active and/or passive scans be performed on behalf of the mobile device 120. The discovery scan module 562 can be configured to operate the wireless interface 425 of the wireless transceiver 115 to perform the requested scan or scans and to collect the results of the scans. The scan request can specify one or more channels on which the discovery scans are to be performed, and the discovery scan module 562 can conduct the scan or scans on the specified channels.

The scan results including information identifying the other wireless transceivers proximate to the wireless transceiver identified during the scan or scans performed by the wireless transceiver can be transmitted to the mobile device (stage 715). The discovery scan module 562 of the wireless transceiver 115 can be configured to send the scan results to the mobile device 120 requesting the scan results via the wireless interface 425. In some implementations, the scan results can be transmitted in the form of a WLAN Radio Measurement Report frame. The scan results can include an identifier that identifies which wireless transceiver 115 conducted a scan and is providing scan results. The scan results can include information such as the channel set and/or channel number for which the scan results apply, measurement start and end times and/or measurement duration, and information identifying one or more wireless transceivers 115 from which signals were received during the scan. The scan results can also identify whether a passive or active scan was performed by the wireless transceiver 115 that conducted the scan.

### LCI Disambiguation

One or more local coordinate systems can be established for an indoor environment to facilitate providing location-based services related to that indoor environment. An indoor environment can be associated with a “location context” and a location server may store associate one or more location context identifiers (LCIs) with the location context. Each LCI can be associated with locally-defined areas of the indoor environment associated with the location context. For example, each floor of an indoor environment may be associated with a different LCI. An LCI is not limited to defining a floor of an indoor environment and may also be associated with other portions of the indoor environment. The floor of a building or other portion of an indoor environment may be mapped according to a local coordinate system rather than a global coordinate system, and this information can be associated with the LCI associated with the floor or other portion of the indoor environment.

An LCI can be associated with information that can be used to assist in determining the position of the mobile device 120. For example, a particular LCI may be associated with maps of the floor or other portion of the indoor environment associated with the LCI. The map information can comprise schematic maps of the floor or other portion of the indoor environment and/or graphs or maps of routes through the floor or other portion of the indoor environment. The map information may also include information that identifies points of interest within the area of the indoor environment represented by the LCI. The map information can include information identifying the position of one or more wireless transceivers 115 within the floor or other portion of the indoor environment associated with the LCI. The map information can also include heatmaps or other representations of measured and/or estimated signal strengths of signals from one or more wireless transceivers 115 disposed throughout the indoor environment from one or more as measured from one or more locations within the area associated with the LCI.

The position determination module 362 can be configured to receive assistance from the location server 160 to determine the location and/or the LCI based on signal measurements obtained by the mobile device 120. In some instance, the position determination module, with our without assistance from the location server 160, can obtain signal measurements from wireless transceivers 115 disposed throughout an indoor environment and the measurements are ambiguous as to which LCI is associated with the current position of the mobile device 120 within the indoor environment.

The techniques illustrated in FIG. 8 can be used to help disambiguate which LCI the mobile device 120 should be associated with. In particular, the technique discussed herein can be useful when moving between LCIs. For example, the technique illustrated in FIG. 8 may be used to determine whether the mobile device 120 has moved from a LCI associated with a first floor of an indoor environment to an LCI associated with a second floor of an indoor environment. The mobile device 120 can then use this information to obtain maps or other information associated with the appropriate LCI that can be used to for position-based and/or navigation services. The technique illustrated in FIG. 8 may provide more accurate LCI disambiguation compared to conventional techniques for LCI disambiguation which may only take into account signal strength from wireless transceivers 115 proximate to the mobile device 120. However, some wireless transceivers 115 may have a higher gain and reflections of signals within the local environment may also interfere with such conventional techniques. Movement of the mobile device 120 and the environment in which the mobile device 120 is operating can also affect the signals measurements obtained from wireless transceivers 115 proximate to the mobile device. For example, the orientation of the mobile device relative to the wireless transceiver 115 can affect the signal strength measurements. Occlusion of the signals by the body of a user of the mobile device 120 can also affect the signal strength measurements. Environmental features, such as furniture and/or equipment in the indoor environment and structural elements of the indoor environment, such as walls and doors, can affect the signal measurements obtained at the mobile device 120. Furthermore, interference from other devices operating within the indoor environment can also affect the signal measurements obtained by the mobile device 120. These and other factors can impact the quality of signal measurements obtained by the mobile device 120.

FIG. 8 is a flow diagram of a process for disambiguation that can make use of the active and/or passive scanning techniques discussed herein. The position determination module 362 can be configured to determine which LCI is associated with a portion of an indoor environment in which the mobile device 120 is located by conducting a discovery scan and then comparing the results of the discovery scan with the results of a discovery scan conducted by one or more wireless transceivers 115 proximate to the mobile device 120. The process illustrated in FIG. 8 can be used to disambiguate which LCI is associated with the current position of the mobile device. The process illustrated in FIG. 8 can be performed by the mobile device 120. The discovery scan module 364 of the mobile device 120 provides means for performing the various stages included in the process illustrated in FIG. 8 unless otherwise specified.

A scan for wireless transceivers proximate to the mobile device 120 can be performed to generate discovery scan results from the scan for wireless transceivers proximate to the mobile device (stage 805). The discovery scan module 364 of the mobile device 120 can be configured to perform either an active or a passive scan for wireless transceivers proximate to the mobile device 120. The discovery scan module 364 can be configured to operate the wireless interface 225 of the mobile device 120 to detect signals from one or more wireless transceivers 115 proximate to the mobile device 120. The discovery scan module 364 can be configured to conduct the discovery scan across one or more channels. The area in which the mobile device 120 is located may include multiple wireless transceivers 115 and these wireless transceivers may be operating on more than one channel. The discovery scan module 364 can be configured to access channel information that indicates which channels the wireless transceivers 115 are most likely to be operating on in the area which the mobile device 120 is located. The discovery scan module 364 can be configured to obtain a coarse position estimate from the position determination module 362 which the discovery scan module 364 can use to select channel information appropriate for the geographic area in which the mobile device is located. The position determination module 362 can also be configured to provide a coarse position estimate based on previously determined position information for the mobile device 120. The channel information can be stored in the memory 260 of the mobile device 120. The discovery scan module 364 can also be configured to obtain the channel information from the location server 160 or another network entity. In some implementations, the channel information may be provided by a mobile network carrier associated with the mobile device 120 at the time that the mobile device is configured to operate with the mobile network carrier's network.

When conducting a passive scan, the discovery scan module 364 can be configured to operate the wireless interface 225 to listen for transmissions from wireless transceivers 115 proximate to the mobile device 120. For example, the discovery scan module 364 can be configured to operate the wireless interface 225 to listen for beacons and/or probe responses where at least a portion of the wireless transceivers 115 comprise WLAN wireless access points. The discovery scan module 364 can be configured to use the beacons, probe responses, and/or other signals transmitted by the wireless transceivers 115 to identify the wireless transceivers 115 transmitting the information. The discovery scan module 364 can also be configured to measure signal strength of the signals received from each of the wireless transceivers 115. For example, the discovery scan module 364 can be configured to measure the signal strength of signals received from the wireless transceivers 115 proximate to the mobile device 120 and to associate Received Signal Strength Indicator (RSSI) values with each of the wireless transceivers 115 from which signals were received. When conducting an active discovery scan, the discovery scan module 364 can be configured to operate the wireless interface 225 to transmit probe requests that include a null SSID name (a probe-any request) to solicit responses from all wireless transceivers 115 configured to receive and respond to such probe requests.

A first wireless transceiver list can be generated based on the discovery scan results from the scan for wireless transceivers proximate to the mobile device, the first wireless transceiver list comprising a first subset of the wireless transceivers proximate to the mobile device, where the wireless transceivers in the first subset of the wireless transceivers proximate to the mobile device are associated with a first location context identifier (LCI) with which the mobile device is associated (stage 810). The discovery scan module 364 can be configured to generate the first wireless transceiver list based on the results of the discovery scan performed by the mobile device 120 which includes a subset of the wireless transceivers proximate to the mobile device and associated with a first LCI with which the mobile device is associated. The discovery scan module 364 can be configured to select one or more wireless transceivers 115 to add to the first wireless transceiver list based on signal measurements. For example, the discovery scan module 364 can be configured to rank the wireless transceivers 115 from which signals were received by the signal strength value associated with each of the wireless transceivers 115. The discovery scan module 364 can be configured to select up to a predetermined number of wireless transceivers 115 to include on the first wireless transceiver list. The discovery scan module 364 can also be configured to include all of the wireless transceivers 115 from which signals were received. In implementations where the discovery scan was an active scan, the discovery scan module 364 can be configured to obtain signal measurements of signals from each of the wireless transceivers 115 from which responses to the probe request were received. For example, the discovery scan module 364 can be configured to use signal measurements such as RSSI (received signal strength indication), RTT (round-trip time)), and time of arrival (TOA) measurements to rank the wireless transceivers 115. In some implementations, the discovery scan module 364 may already have created a first wireless transceiver list and the discovery scan module 364 can be configured to update the existing list based on the first discovery scan results resulting from the discovery scan conducted in stage 805.

A second wireless transceiver list can be generated based on the discovery scan results from the scan for wireless transceivers 115 proximate to the mobile device 120, the second wireless transceiver list comprising a second subset of the wireless transceivers 115 proximate to the mobile device 120, where the wireless transceivers in the second subset of the wireless transceivers proximate to the mobile device are associated with a second LCI, wherein the second LCI is different from the first LCI (stage 815). The second wireless transceiver list includes a subset of the wireless transceivers proximate to the mobile device (as determined by the discovery scan conducted by the mobile device 120) and associated with a second LCI which is different than the first LCI with which the mobile device 120 is associated. In some implementations, the second wireless transceiver list can include subsets of wireless transceivers 115 that are each associated with more than one LCI that is different than the first LCI with which the mobile device 120 is associated. The discovery scan module 364 can be configured to generate the second wireless transceiver list based on the results of the discovery scan. The discovery scan module 364 can be configured to compare LCI information associated with each of the wireless transceivers 115 detected in the discovery scan with the first LCI currently associated with the mobile device 120 and to add the wireless transceivers 115 associated with a different LCI than the current LCI to the second wireless transceiver list. The discovery scan module 364 can use this information to determine whether the mobile device 120 is located in a portion of the indoor environment associated with a first LCI in which the mobile device 120 is currently believed to be located or is actually located in another LCI associated with the one or more wireless transceivers 115 associated with a different LCI.

A first scan request can be transmitted to at least one wireless transceiver from first wireless transceiver list requesting the at least one wireless transceiver from the first wireless transceiver list perform a scan for wireless transmitters proximate to the at least one wireless transceiver from the first wireless transceiver list (stage 820), and a second scan request can be transmitted to at least one wireless transceiver from the second wireless transceiver list requesting the at least one wireless transceiver from the second wireless transceiver list perform a discovery scan for wireless transmitters proximate to the at least one wireless transceiver from the second wireless (stage 825). The discovery scan module 364 can be configured to select one or more of the wireless transceivers from the first wireless transceiver list and at least one wireless transceiver from the second wireless transceiver list and send a scan request to the each of the selected wireless transceivers 115 to perform a scan for other wireless transceivers 115 on behalf of the mobile device 120. The discovery scan module 364 can be configured to send the request to the selected wireless transceiver or transceivers 115 from each list in the form of a WLAN Radio Measurement frame. The request can also specify a scan type to be performed. For example, the request can specify whether an active or a passive scan is being requested. The wireless transceivers 115 receiving the request can be configured to perform the requested active and/or passive scan and to provide the results of the scan to the mobile device 120. The scan request can specify one or more channels on which the mobile device 120 is requesting that the one or more wireless transceivers 115 perform the active and/or passive scans. The discovery scan module 364 can be configured to send the request to the selected wireless transceiver or transceivers 115 from each list in the form of a WLAN Radio Measurement frame. The scan request can specify one or more channels on which the mobile device 120 is requesting that the one or more wireless transceivers 115 perform the active and/or passive scans. The discovery scan module 364 can be configured to select multiple wireless transceivers 115 to perform multiple scans in parallel with one another. The scans can be conducted on multiple channels at once and can significantly decrease the amount of time that would be required to conduct a discovery scan. Furthermore, the discovery scans conducted by the wireless transceivers 115 may also be more accurate, as the wireless transceivers typically operate a higher transmit and receive power than the mobile device 120 and thus be more sensitive than the mobile device 120 providing more accurate results. Furthermore, wireless transceivers 115 that have switched to a different channel or those do not broadcast an SSID or other identifier may also be detected more quickly as the discovery scan can be conducted across multiple channels at once by the wireless transceivers 115.

Discovery scan results from the wireless transceivers from first wireless transceiver list can be received (stage 830), and discovery scan results from the wireless transceivers from second wireless transceiver list can be received (stage 835). The scan results from each of the wireless transceivers 115 can include information that identifies the wireless transceivers 115 proximate to that wireless transceiver 115 that were detected during the scan. In some implementations, the scan results comprise one or more WLAN Radio Measurement Report frames. The scan results can include an identifier that identifies which wireless transceiver 115 conducted a scan and is providing scan results. The scan results can include information such as the channel set and/or channel number for which the scan results apply, measurement start and end times and/or measurement duration, and information identifying one or more wireless transceivers 115 from which signals were received during the scan. The scan results can also identify whether a passive or active scan was performed by the wireless transceiver 115 that conducted the scan.

The discovery scan results from the scan for wireless transceivers proximate to the mobile device with the discovery scan results from the at least one wireless transceiver from the first wireless transceiver list and the discovery scan results from the at least one wireless transceiver from the second wireless transceiver list can then be compared (stage 840). The discovery scan module 364 of the mobile device can be configured to compare the results of the discovery scan conducted by the mobile device 120 with the discovery scan results obtained from the wireless transceivers on the first wireless transceiver list and the discovery scan results obtained from the wireless transceivers on the second wireless transceiver list. For example, the discovery scan module 364 can compare identifiers of wireless transceivers included first discovery scan results with identifiers of wireless transceivers included in the second and the third discovery scan results to identify wireless transceivers included in the first discovery scan results and also in the second or third discovery scan results.

An LCI associated with the portion of the indoor environment in which the mobile device is located can be determined based at least in part on the comparison (stage 845). The discovery scan module 364 and/or the position determination module 362 can be configured to disambiguate the LCI associated with the mobile device based on the results of the comparison from stage 840. For example, if the discovery scan module 364 determines that the results of the discovery scan conducted by the mobile device 120 includes more of the same wireless transceivers 115 that were included in the second discovery scan results provided by the wireless transceivers 115 on the first wireless transceiver list than were included in the third discovery scan results provided by the wireless transceivers 115 on the second wireless transceiver list, the discovery scan module 364 can be configured to maintain the association of the mobile device 120 with the first LCI which the mobile device 120 is currently associated. However, if the discovery scan module 364 determines that the results of the discovery scan conducted by the mobile device 120 includes more of the same wireless transceivers 115 that were included in the third discovery scan results than were included in the second discovery scan results, the discovery scan module 364 can be configured to associate the mobile device with a new LCI.

In some situations, the mobile device 120 may be proximate to multiple different LCIs. For example, the mobile device 120 may be located near an atrium, stairway, escalator, or other portion of an indoor environment where the mobile device 120 can receive signals from wireless transceivers 115 on multiple floors or sections of the indoor environment. In such a situation, the second wireless transceiver list may include wireless transceivers 115 associated with more than one LCI other than the LCI with which the mobile device is currently associated. In such a situation, the discovery scan results received from the wireless transceivers 115 of the second wireless transceiver list may be grouped by LCI, such that discovery scan results from wireless transceivers from the same LCI are grouped together. When the mobile device 120 makes a determination whether the mobile device 120 should remain with the current LCI or transition to a new LCI, the discovery scan module 364 can be configured to select an LCI from the multiple LCIs that provides a better match than the current LCI based on the number of wireless transceivers 115 from the scan results associated with that LCI that match the discovery scan results conducted by the mobile device 120. For example, the discovery scan module 364 can be configured to select a new LCI from the plurality of LCIs if the discovery scan module 364 determines that the results of the discovery scan conducted by the mobile device 120 includes more of the same wireless transceivers 115 that were included in the discovery scan results provided by the wireless transceivers 115 in the group of wireless transceivers associated with that LCI than were included in the scan results provided by the wireless transceivers 115 on the first wireless transceiver list. The discovery scan module 364 can be configured to select the new LCI has the most matches when compared to the other LCIs for which discovery scan results were obtained.

By disambiguating the LCI, the discovery scan module 364 can associate the mobile device with an LCI that is most appropriate to the current location of the mobile device 120. Selecting the correct LCI to associate with the mobile device can result in the mobile device 120 being provided location-based services that are appropriate to the current location of the mobile device. For example, indoor navigation for a floor associated with the LCI can be provided to the mobile device 120 and the position determination module 362 can use this information to provide a user of the mobile device 120 with navigation instructions for navigating that floor of the indoor environment. If the wrong LCI were selected, navigation information associated with a different floor or area of the indoor environment may be accessed instead of the information associated with the floor or area in which the mobile device is actually located.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method, on a mobile device, for determining a position, comprising:
performing a passive scan for wireless transceivers proximate to the mobile device to generate passive scan results;
generating a first wireless transceiver list, comprising a first set of wireless transceivers;
transmitting a request to at least one wireless transceiver from the first wireless transceiver list requesting that the at least one wireless transceiver perform a scan for wireless transceivers;
receiving scan results from the at least one wireless transceiver from the first wireless transceiver list;
generating a second wireless transceiver list comprising identifying information for a second set of wireless transceivers, proximate to the at least one wireless transceiver;
measuring signals received from wireless transceivers selected from the first wireless transceiver list, or the second wireless transceiver list, or combination thereof; and
determining the position of the mobile device based at least in part on the signals measured.

2. The method of claim 1 wherein the request comprises a wireless local area network (WLAN) Radio Measurement frame comprising a Beacon Request.

3. The method of claim 1 wherein the request comprises a request to perform an active scan for the wireless transceivers.

4. The method of claim 1 wherein the request comprises a request to perform a passive scan for the wireless transceivers.

5. The method of claim 1 further comprising:
periodically performing additional passive scans for the wireless transceivers proximate to the mobile device; and
updating the first wireless transceiver list based on results of the additional passive scans.

6. The method of claim 5, wherein updating the first wireless transceiver list comprises:
removing one or more wireless transceivers from the first wireless transceiver list responsive to a signal strength associated with each of the one or more wireless transceivers from the first wireless transceiver list falling below a first predetermined threshold.

7. The method of claim 6, wherein updating the first wireless transceiver list comprises:
adding one or more wireless transceivers that are currently not on the first wireless transceiver list to the first wireless transceiver list responsive to the signal strength associated with each of the one or more wireless transceivers that are currently not on the first wireless transceiver list exceeding a second predetermined threshold.

8. The method of claim 1, wherein the wireless transceivers comprise WLAN access points.

9. A mobile device configured for determining a position of the mobile device, the mobile device comprising:
a tangible, non-transitory computer-readable memory;
a transceiver configured to perform a passive scan for wireless transceivers proximate to the mobile device to generate passive scan results;
a processor connected to the tangible, non-transitory computer-readable memory and configured to generate a first wireless transceiver list, comprising a first set of wireless transceivers;
the transceiver further configured to transmit a request to at least one wireless transceiver from the first wireless transceiver list requesting that the at least one wireless transceiver perform a scan for wireless transceivers and to receive scan results from the at least one wireless transceiver from the first wireless transceiver list;
the processor further configured to:
generate a second wireless transceiver list comprising identifying information for a second set of wireless transceivers, proximate to the at least one wireless transceiver;
measure signals received from wireless transceivers selected from the first wireless transceiver list, or the second wireless transceiver list, or combination thereof; and
determine the position of the mobile device based at least in part on the signals measured.

10. The mobile device of claim 9 wherein the request comprises a wireless local area network (WLAN) Radio Measurement frame comprising a Beacon Request.

11. The mobile device of claim 9 wherein the request comprises a request to perform an active scan for the wireless transceivers.

12. The mobile device of claim 9 wherein the request comprises a request to perform a passive scan for the wireless transceivers.

13. The mobile device of claim 9 wherein the processor is further configured to:
periodically perform additional passive scans for the wireless transceivers proximate to the mobile device; and
update the first wireless transceiver list based on results of the additional passive scans.

14. The mobile device of claim 13, wherein the processor is further configured to:
remove one or more first wireless transceivers from the first wireless transceiver list responsive to a signal strength associated with each of one or more wireless transceivers from the first wireless transceiver list falling below a first predetermined threshold.

15. The mobile device of claim 14, wherein the processor is further configured to:
add one or more second wireless transceivers currently not on the first wireless transceiver list to the first wireless transceiver list responsive to the signal strength associated with each of the one or more second wireless transceivers currently not on the first wireless transceiver list exceeding a second predetermined threshold.

16. A method for disambiguation of a location context associated with a mobile device comprising:
performing a scan for wireless transceivers proximate to the mobile device to generate discovery scan results from the scan for wireless transceivers proximate to the mobile device;
generating a first wireless transceiver list based on the discovery scan results from the scan for wireless transceivers proximate to the mobile device, the first wireless transceiver list comprising a first subset of the wireless transceivers proximate to the mobile device, and wherein wireless transceivers in the first subset of the wireless transceivers proximate to the mobile device are associated with a first location context identifier (LCI) with which the mobile device is associated;
generating a second wireless transceiver list based on the discovery scan results from the scan for wireless transceivers proximate to the mobile device, the second wireless transceiver list comprising a second subset of the wireless transceivers proximate to the mobile device, and wherein wireless transceivers in the second subset of the wireless transceivers proximate to the mobile device are associated with a second LCI, wherein the second LCI is different from the first LCI;
transmitting a first scan request to at least one wireless transceiver from the first wireless transceiver list requesting the at least one wireless transceiver from the first wireless transceiver list perform a scan for wireless transmitters proximate to the at least one wireless transceiver from the first wireless transceiver list;
transmitting a second scan request to at least one wireless transceiver from the second wireless transceiver list requesting the at least one wireless transceiver from the second wireless transceiver list perform a discovery scan for wireless transmitters proximate to the at least one wireless transceiver from the second wireless transceiver list;
receiving discovery scan results from the at least one wireless transceiver from the first wireless transceiver list;
receiving discovery scan results from the at least one wireless transceiver from the second wireless transceiver list;
comparing the discovery scan results from the scan for wireless transceivers proximate to the mobile device with the discovery scan results from the at least one wireless transceiver from the first wireless transceiver list and the discovery scan results from the at least one wireless transceiver from the second wireless transceiver list; and
determining an LCI associated with a portion of an indoor environment in which the mobile device is located based at least in part on results of comparison.

17. The method of claim 16 wherein the first scan request or the second scan request or both comprise a request to perform an active scan for the wireless transceivers.

18. The method of claim 16 wherein the first scan request or the second scan request or both comprise a request to perform a passive scan for the wireless transceivers.

19. The method of claim 16 wherein determining the LCI associated with the portion of the indoor environment in which the mobile device is located based at least in part on results of comparison further comprises selecting the LCI based on a number of wireless transceivers included in the discovery scan results from the scan for wireless transceivers proximate to the mobile device, the discovery scan results from the at least one wireless transceiver from the first wireless transceiver list, and the discovery scan results from the at least one wireless transceiver from the second wireless transceiver list associated with the LCI.
